(19) United States
(12) Patent Application Publication
(10) Pub. No.: US 2007/0074538 A1
(43) Pub. Date: Apr. 5, 2007

(54) Refrigeration cycle device

(75) Inventors: Syun Kurata, Kariya-city (JP); Yoshiaki Takano, Kosai-city (JP); Kenji Ogura, Kariya-city (JP); Takahisa Suzuki, Nagoya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/516,166

(22) Filed: Sep. 6, 2006

(30) Foreign Application Priority Data
Sep. 7, 2005 (JP) 2005-259694

(51) Int. Cl. F25B 41/00; B60H 1/32; F25B 1/00

(52) U.S. Cl. 62/513; 62/239; 62/498

(57) ABSTRACT

A refrigeration cycle device includes a double tube for exchanging heat between a high-pressure refrigerant to be decompressed by a decompressor and a low-pressure refrigerant to be drawn by a compressor. The decompressor controls a dryness and a superheat degree of an outlet side refrigerant flowing from an outlet of the low-pressure side heat exchanger to the double tube in accordance with a temperature of the outlet side refrigerant or a suction side refrigerant flowing from the double tube to a suction port of the compressor. Thus, the dryness of the outlet side refrigerant is equal to or larger than 0.9 and the superheat degree of the outlet side refrigerant is equal to or lower than 5° C.

### CROSS REFERENCE TO RELATED APPLICATION

This application is based on Japanese Patent Application No. 2005-259694 filed on Sep. 7, 2005, the contents of which are incorporated herein by reference in its entirety.

### BACKGROUND OF THE INVENTION

1. Field of the Invention

The present invention relates to a refrigeration cycle device including a double tube having an outer tube and an inner tube. The device can be suitably used in an air-conditioning apparatus for an automotive vehicle.

2. Description of Related Art

Patent Document 1 discloses a refrigeration cycle device. In the device, a compressor, a radiator, an expansion valve and an evaporator are circularly connected in this order by a refrigerant pipe. The device further includes an internal heat exchanger for exchanging heat between a high-pressure refrigerant to be decompressed by the expansion valve and a low-pressure refrigerant to be drawn by the compressor. A load-applying portion for applying an initial load to a valve spring is formed integrally with a housing of the expansion valve. An elastic force from the spring is applied to a diaphragm and a valve plug in the expansion valve, and the load-applying portion is fixed to the housing.

Accordingly, an enthalpy difference between refrigerants at an inlet and an outlet of the evaporator is increased, because refrigerant flowing into the expansion valve is cooled by the internal heat exchanger. Thus, heat-absorbing performance of the evaporator can be enhanced. Further, refrigerant to be drawn by the compressor can be superheated without a preload-adjusting portion of the expansion valve. Therefore, the refrigeration cycle device can be stably used, because a liquid compression can be prevented in the compressor.

[Patent Document 1] JP-A-2004-270966

FIG. 6 in Patent Document 1 shows a range, in which the evaporator can stably operate. However, an appropriate refrigerant state, especially an appropriate superheat degree, at an outlet side of the evaporator is not indicated in the refrigeration cycle device. That is, if refrigerant is too much superheated at the outlet side of the evaporator, a temperature of refrigerant discharged from the compressor may also be increased. Thus, endurance performance for related parts disposed at a high-pressure side of the refrigeration cycle device may be affected.

### SUMMARY OF THE INVENTION

In view of the foregoing and other problems, it is an object of the present invention to provide a refrigeration cycle device. According to the device, cooling performance can be increased, and endurance performance for related parts disposed at a high-pressure side can be secured.

According to an example of the present invention, a refrigeration cycle device includes a refrigeration cycle constructed with a compressor, a high-pressure side heat exchanger, a decompressor and a low-pressure side heat exchanger, which are connected in this order by a pipe. Refrigerant drawn and compressed by the compressor circulates in the refrigeration cycle. A double tube located in the refrigeration cycle includes an outer tube and an inner tube, which form two passages therebetween and inside of the inner tube. High-pressure refrigerant to be decompressed by the decompressor exchanges heat with low-pressure refrigerant to be drawn by the compressor. The decompressor includes a thermal expansion valve, which controls a state of an outlet side refrigerant from an outlet of the low-pressure side heat exchanger to the double tube, or a state of a suction side refrigerant from the double tube to a suction port of the compressor, by adjusting an opening degree of the expansion valve in accordance with a temperature of the outlet side refrigerant or the suction side refrigerant. The decompressor has an enclosed space sealed with a gas, in which a pressure of the gas varies in accordance with the temperature of the outlet side refrigerant or the suction side refrigerant to adjust the opening degree. The gas has a saturated liquid characteristic, which approximately corresponds to a parallel-moved saturated liquid characteristic obtained by moving a saturated liquid characteristic of the refrigerant in parallel along a temperature axis direction of a saturated liquid line graph. The decompressor controls a state of the outlet side refrigerant in a range of a dryness equal to or larger than 0.9 and in a range of a superheat degree equal to or lower than 5° C.

A cooling performance of the double tube can be increased, when the outlet side refrigerant has a dryness equal to or more than 0.9. In contrast, a low-pressure refrigerant discharged from the low-pressure side heat exchanger is superheated by 15° C. at maximum using a high-pressure refrigerant in the double tube. Here, in a high-load condition for cooling, if the suction side refrigerant has a superheat degree larger than a predetermined value, a temperature of refrigerant compressed by the compressor becomes too high. When this high-temperature state continues for a long time or frequently happens, endurance performance for parts disposed at a discharge side of the compressor may be lowered. Therefore, the superheat degree of the outlet side refrigerant is restricted to be low such that a temperature of the discharge side of the compressor is not excessively increased. For example, when an upper limit for a superheat degree of the suction side refrigerant is set about 20° C., the temperature of the discharge side of the compressor is not excessively increased in most of driving conditions. In this case, the superheat degree of 15° C. due to the double tube is subtracted from the superheat degree of 20° C. of the upper limit. Thus, a superheat degree of the outlet side refrigerant is restricted less than 5° C. Accordingly, by controlling the outlet side refrigerant in the range of the dryness equal to or larger than 0.9 and in the range of the superheat degree equal to or lower than 5° C., the cooling performance of the refrigeration cycle device can be improved, and endurance performance for parts disposed at a high-pressure side can be secured.

The decompressor uses a gas, so that a saturated liquid characteristic of the gas is parallel to a saturated liquid characteristic of the refrigerant. Therefore, a rapid increase in a temperature of the refrigerant can be restricted. Even when a temperature of a discharged refrigerant is increased by the double tube, the temperature does not exceed a withstand temperature for machinery. For example, when a cooling load or an outlet side pressure of the low-pressure side heat exchanger varies, an unexpected increase in the temperature can be reduced. Thus, the refrigeration cycle can stably operate with an advantage of the double tube in a range from a low-load area to a high-load area, for example.

The double tube may have a heat-exchanging amount such that the suction side refrigerant is superheated to 20° C. at maximum, when the outlet side refrigerant is in the range of the dryness equal to or larger than 0.9 and in the range of the superheat degree equal to or lower than 5° C.

The thermal expansion valve may control the outlet side refrigerant to have a superheat degree of about 0° C. at least at a high-load time. Thereby, the superheat degree of the outlet side refrigerant is lowered by 5° C. (5° C.-0° C.), compared with a case in which the outlet side refrigerant has the superheat degree of 5° C. Thus, a safe rate due to endurance performance for parts at a high-pressure side can be enhanced, especially in a high-load condition, because a temperature of refrigerant compressed by the compressor can be lowered.

The refrigerant may be an HFC134a refrigerant. In this case, pressure tightness for the outer tube and the inner tube of the double tube can be maintained, and an efficient cooling performance can be obtained. As a characteristic of the HFC134a, when a refrigerant temperature in the low-pressure side heat exchanger is about 0° C., a low-pressure refrigerant has a pressure of 0.2 MPaG. When a refrigerant temperature in the high-pressure side heat exchanger is about 60° C., a high-pressure refrigerant has a pressure of 2 MPaG. Thus, the refrigerant can have a predetermined range of temperature, and the double tube can keep its pressure tightness in the predetermined range.

The refrigeration cycle device may be used in an air-conditioning apparatus for an automotive vehicle. In this case, a high-pressure refrigerant can be cooled by exchanging heat with a low-pressure refrigerant. Then, a cooling performance can be improved without increasing a power of the compressor. Thus, efficiency for the refrigeration cycle can be improved. Therefore, especially in the case of the air-conditioning apparatus for the automotive vehicle, a gas mileage of the vehicle can be better, which is remarkably demanded recently. Further, if a high-temperature air heated by an engine in an engine room is drawn by the high-pressure side heat exchanger, a refrigerant-cooling performance by the high-pressure side heat exchanger is lowered. However, the double tube can reduce the lowering of the refrigerant-cooling performance.

The refrigeration cycle device may further include a bypass passage, a second decompressor and a second low-pressure side heat exchanger, when the decompressor and the low-pressure side heat exchanger are respectively used as a first decompressor and a first low-pressure side heat exchanger. Through the bypass passage, refrigerant bypasses the first decompressor and the first low-pressure side heat exchanger. Furthermore, the second decompressor and the second low-pressure side heat exchanger are disposed in the bypass passage. In this case, the double tube is disposed such that heat is exchanged between a high-pressure refrigerant flowing into a branch point of the bypass passage, and a low-pressure refrigerant from a confluent point of the bypass passage to the compressor. Thereby, cooling performance can be improved in both of the first and second low-pressure side heat exchangers, because the high-pressure refrigerant supercooled by the double tube can flow toward both of the first and second low-pressure side heat exchangers.

The second decompressor may control an outlet side refrigerant from an outlet of the second low-pressure side heat exchanger to the confluent point in a range of a dryness equal to or larger than 0.9 and in a range of a superheat degree equal to or lower than 5° C. Thereby, a superheat degree of the outlet side refrigerant can be reduced in the second low-pressure side heat exchanger, similarly to the first low-pressure side heat exchanger. Thus, a temperature of refrigerant compressed by the compressor can be reduced.

When the compressor has an upper limit for a temperature in order to reduce a lowering in endurance performance of resin parts disposed at a discharge side of the compressor, the outlet side refrigerant state of the compressor is controlled such that a temperature of refrigerant discharged from the compressor is equal to or less than the upper limit, even if the temperature varies due to a load variation in a high-load area.

### BRIEF DESCRIPTION OF THE DRAWINGS

Additional objects and advantages of the present invention will be more readily apparent from the following detailed description of preferred embodiments when taken together with the accompanying drawings. In the drawings:

FIG. 1 is a schematic diagram showing an air-conditioning apparatus for an automotive vehicle;

FIG. 2 is a perspective view showing a refrigeration cycle device;

FIG. 3 is a schematic cross-sectional view showing an expansion valve;

FIG. 4 is a saturated liquid line graph showing a saturated liquid characteristic of a working gas in the expansion valve;

FIG. 5 is a schematic cross-sectional view showing a double tube;

FIG. 6 is a graph showing a Mollier diagram for the refrigeration cycle device;

FIG. 7 is a graph showing a favorable dryness range or a superheat degree range in an evaporator or a compressor;

FIG. 8 is a graph showing temperatures of refrigerant at a discharging side of the compressor based on driving conditions at a high-load time;

FIG. 9 is a graph showing temperatures of the refrigerant at a discharging side of the compressor based on the working gases;

FIG. 10 is a schematic diagram showing a refrigeration cycle device according to a second embodiment;

FIG. 11 is a schematic diagram showing a refrigeration cycle device having a double tube in a dual air-conditioner according to a third embodiment; and

FIG. 12 is a schematic diagram showing a refrigeration cycle device having two double tubes in a dual air-conditioner.

### DETAILED DESCRIPTION OF PREFERRED EMBODIMENTS

### First Embodiment

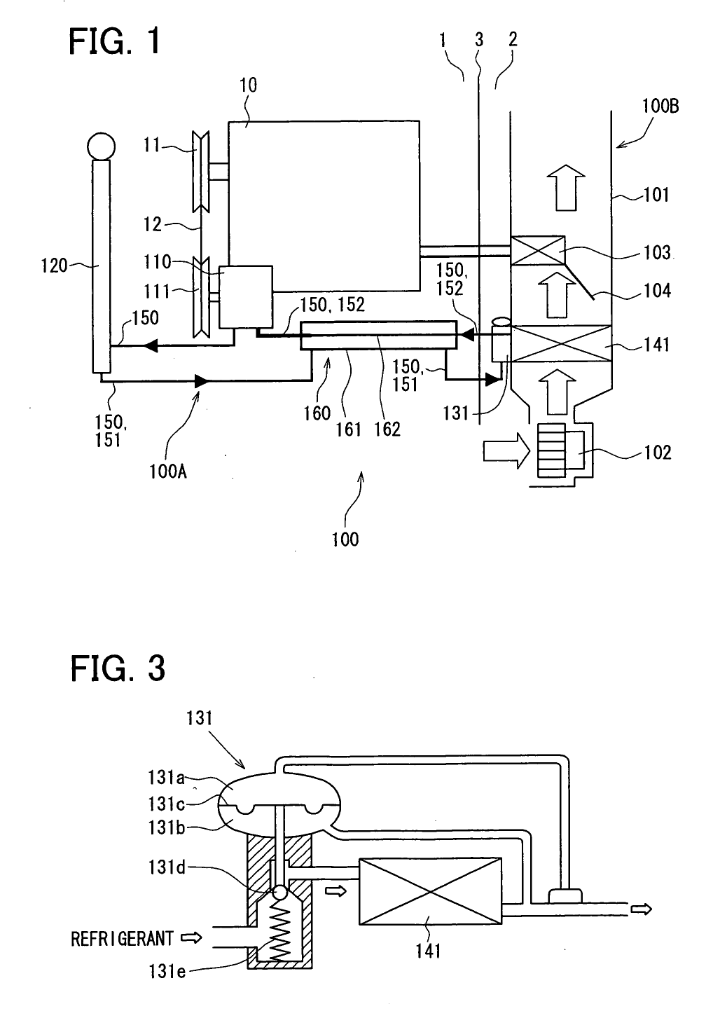

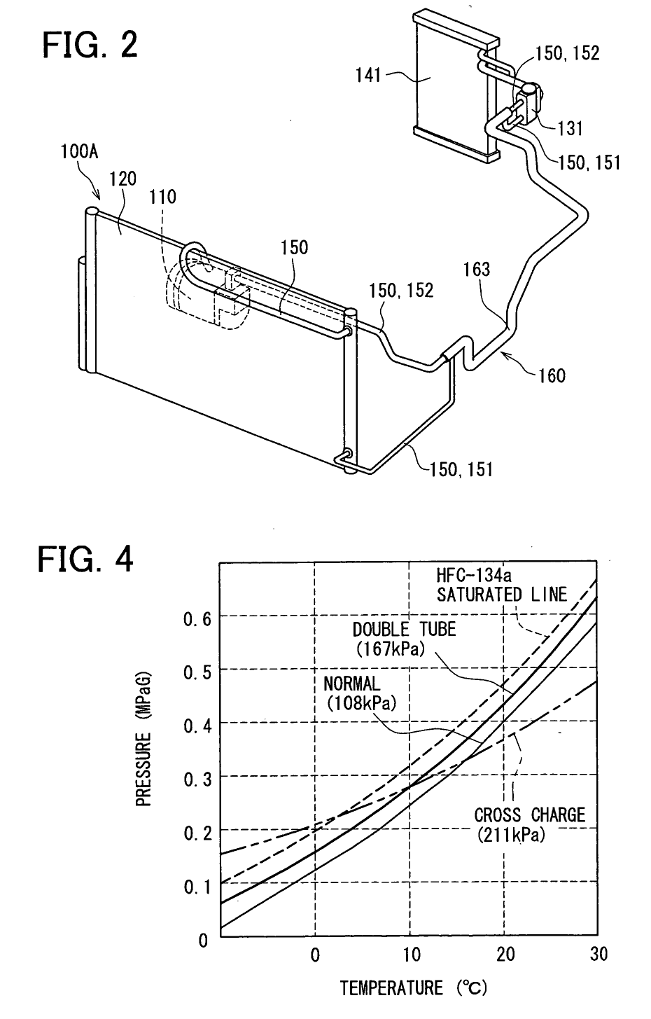

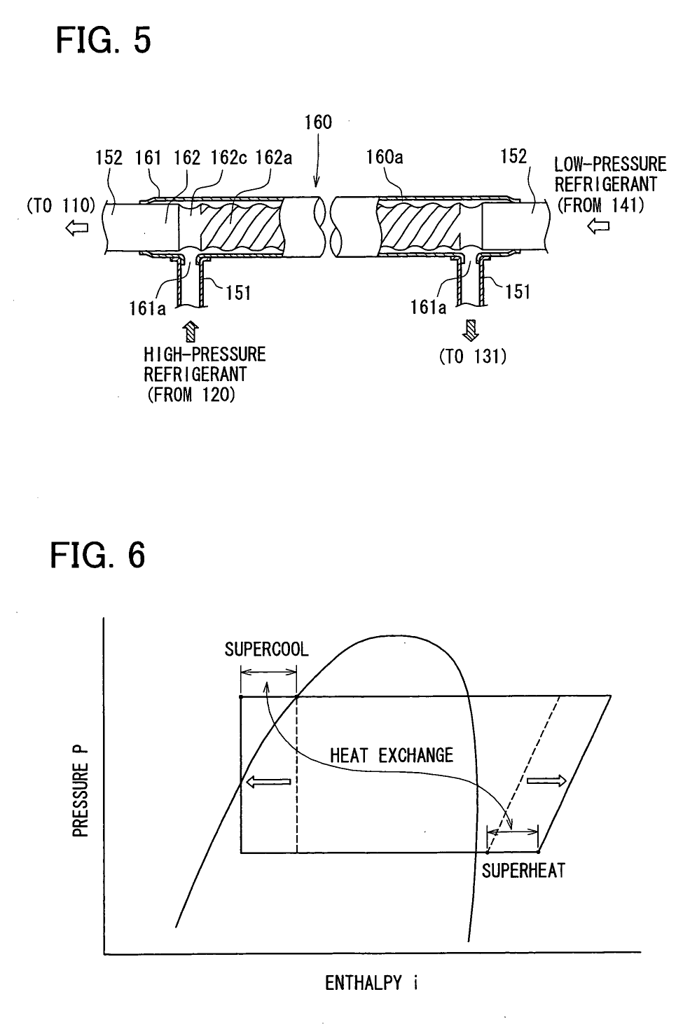

A refrigeration cycle device 100A in a first embodiment is used in an air-conditioning apparatus 100 for an automotive vehicle (hereinafter referred to as air-conditioning apparatus). A specific structure for the device 100A will be described with reference to FIGS. 1-5. FIG. 1 is a schematic diagram showing the air-conditioning apparatus 100; FIG. 2 is a perspective view showing the refrigeration cycle device 100A; FIG. 3 is a cross-sectional view showing an expansion valve 131; FIG. 4 is a saturated liquid line graph showing a saturated liquid characteristic of a working gas in the expansion valve 131; and FIG. 5 is a schematic cross-sectional view showing a double tube 160.

As shown in FIGS. 1 and 2, an automobile is separated into an engine compartment 1 for an engine 10 and a vehicle compartment 2 for occupants by a dash panel 3. The refrigeration cycle device 100A except for the expansion valve 131 and an evaporator 141 is disposed in the engine compartment 1, and an interior unit 100B is disposed in an instrument panel in the vehicle compartment 2. The air-conditioning apparatus 100 is constructed with the refrigeration cycle device 100A and the interior unit 100B.

The interior unit 100B includes a blower 102, the evaporator 141 and a heater core 103 in an air-conditioning case 101. The blower 102 selectively sucks an outside air or an inside air of the automobile as an air-conditioning air, and sends the air-conditioning air to the evaporator 141 and the heater core 103. The evaporator 141 evaporates refrigerant, when the refrigeration cycle device 100A operates. The operation will be described below. The evaporator 141 is a heat exchanger for cooling the air-conditioning air by a latent heat of the evaporation. The heater core 103 is a heat exchanger for heating the air-conditioning air from the evaporator 141 by using hot water from the engine 10 as a heating source.

In addition, an air mixing door 104 is disposed adjacent to the heater core 103 in the air-conditioning case 101, and the door 104 adjusts a mixing ratio of air cooled by the evaporator 141 and air heated by the heater core 103 by adjusting its opening degree. Thus, the mixed conditioned air is obtained to have a predetermined temperature set by the occupants.

Pipes 150 connect a compressor 110, a condenser 120, the expansion valve 131 and the evaporator 141 in this order in the refrigeration cycle device 100A, and form a closed cycle. The double tube 160 is disposed between the pipes 150. The condenser 120 is a heat exchanger at a high-pressure side, and operates as a radiator or a gas cooler. The evaporator 141 is a heat exchanger at a low-pressure side, and operates as a cooling unit or a heat absorber. The expansion valve 131 is a decompressor, and a throttle, a valve or an ejector may be used as the expansion valve 131.

The compressor 110 is fluid machinery for compressing refrigerant to have a high-temperature and a high-pressure in the refrigeration cycle device 100A, and driven by the engine 10. That is, a pulley 111 is fixed to a driving axis of the compressor 110, and a driving force by the engine 10 is transmitted to the pulley 111 through a crank pulley 11 and a driving belt 12. In addition, an electromagnetic clutch (not shown) is disposed between the driving axis and the pulley 111. The condenser 120 is connected to a discharging side of the compressor 110. The condenser 120 is a heat exchanger for condensing refrigerant to a liquid phase by exchanging heat with outside air.

The expansion valve 131 isentropically decompresses the liquid phase refrigerant discharged from the condenser 120 to be expanded. The expansion valve 131 is disposed adjacent to the evaporator 141 in the interior unit 100B. The expansion valve 131 thermally controls its opening degree such that an outlet side refrigerant is in a state having a dryness equal to or larger than 0.9 and a superheat degree equal to or lower than 5° C. Here, the outlet side refrigerant represents refrigerant from an outlet of the evaporator 141 to the double tube 160. The expansion valve 131 is a decompressor. The opening degree of the expansion valve 131 is adjusted in accordance with a temperature of the outlet side refrigerant or a suction side refrigerant. The suction side refrigerant represents refrigerant from the double tube 160 to a suction port of the compressor 110. Thus, the expansion valve 131 controls a state of the outlet side refrigerant or a state of the suction side refrigerant. The opening degree of the expansion valve 131 may be adjusted in accordance with a temperature of the suction side refrigerant from the double tube 160 to the suction port of the compressor 110. The expansion valve 131 has an enclosed space, in which gas is sealed and a pressure of the gas varies in accordance with a temperature of the outlet side refrigerant or the suction side refrigerant. The opening degree of the expansion valve 131 is adjusted by the pressure of the sealed gas. The sealed gas has a saturated liquid characteristic. When a saturated liquid characteristic line of the refrigerant is moved in parallel along a temperature axis of a saturated liquid line graph, the moved line is approximately equal to the saturated liquid characteristic line of the sealed gas. Therefore, the expansion valve 131 may be defined as a normal charge expansion valve.

The expansion valve 131 shows a specified characteristic in a broad range from a low-pressure to a high-pressure. The specified characteristic is approximately parallel to the saturate liquid characteristic of the refrigerant. Therefore, a variation in a temperature of a discharged refrigerant of the compressor 110 can be reduced in the broad range from the low-pressure to the high-pressure. For example, when a load is much increased in a high-load area, the temperature of the discharged refrigerant is restricted from increasing to a withstand temperature. For example, an excessive increase in the temperature of the discharged refrigerant can be restricted in a broad range from a low-load to a high-load. Further, even when a load is excessively increased, an excessive increase in the temperature of the discharged refrigerant can be restricted. Therefore, the refrigerant temperature is restricted from increasing to a high temperature, at which machinery is affected. The expansion valve 131 can be used in an air-conditioning apparatus for an automobile, in which a load variation is large.

In this embodiment, a difference of increasing amounts in the temperature of the discharged refrigerant can be reduced between when a load varies in a low-load area and when the load varies in a high-load area. Thus, a sudden increase in the temperature can be restricted from exceeding an upper limit in the high-load area. A temperature characteristic of the expansion valve 131 is set such that the temperature of the discharged refrigerant does not exceed the upper limit when the load varies in the high-load area. Even if the temperature exceeds the upper limit, its frequency is set to reduce. The upper limit is set such that endurance performance of parts made of resin at a discharge side of the compressor 110 can be restricted from decreasing. In this case, the expansion valve 131 controls the outlet side refrigerant such that the temperature of the discharged refrigerant can be restricted from exceeding the upper limit when the temperature varies due to a load variation in the high-load area. Thus, the expansion valve 131 can be used with a high performance in a middle-load area, which is frequently used.

More specifically, as shown in FIG. 3, the expansion valve 131 includes a first pressure room 131a, a second pressure room 131b, a membrane-shaped diaphragm 131c, a valve plug 131d and a valve spring 131e. The first pressure room 131a and the second pressure room 131b are separated by the membrane-shaped diaphragm 131c. The valve plug 131d is positioned at an outside of the second pressure room 131b so as to be opposite to the diaphragm 131c. When the diaphragm 131c is displaced toward the second pressure room 131b, the valve plug 131d is displaced such that the opening degree is increased. The spring 131e gives an elastic force to the first pressure room 131a to decrease its volume through the valve plug 131d.

A predetermined amount of a working gas is sealed in the first pressure room 131a. The sealed gas is in a saturated state, in which a vapor and a liquid coexist. A pressure in the first pressure room 131a varies in accordance with a temperature of the outlet side refrigerant of the evaporator 141. Further, a pressure of refrigerant flowing from the outlet side of the evaporator 141 corresponds to a pressure of the second pressure room 131b. Therefore, when a superheat degree of refrigerant at the outlet side of the evaporator 141 reaches a predetermined value, the pressure of the working gas is higher than that of the refrigerant flowing out of the evaporator 141 due to the superheat degree. Then, a pressure difference generates between the first and second pressure rooms 131a, 131b. When the difference exceeds the elastic force of the spring 131e, the valve plug 131d is opened, and an amount of refrigerant flowing into the evaporator 141 is increased. Thus, the refrigerant temperature is decreased, and the pressure difference is decreased, thereby the valve plug 131d is closed. By repeating this, the outlet side refrigerant of the evaporator 141 can be maintained to have a predetermined superheat degeree.

As shown in FIG. 4, the working gas has a saturated liquid line. (A thin line represents a normal saturated liquid line, and a heavy line represents a saturated liquid line for a double tube.) Refrigerant (HFC-134a) used in the refrigeration cycle device 100A has a dashed saturated liquid line. The heavy line and the thin line can be obtained by moving the dashed line in parallel along a temperature axis direction toward a high-temperature side. The superheat degree at the outlet side is set to be 0-3° Cl (at least 5° C. or less such that the refrigerant has little superheat) by a selection of the working gas and a setting of the spring 131e.

As described above, the evaporator 141 is the heat exchanger for cooling the air-conditioning air by the evaporation of the refrigerant discharged from the expansion valve 131. A refrigerant outlet side of the evaporator 141 is connected to a refrigerant suction side of the compressor 110.

The pipes 150 include a high-pressure pipe 151 for flowing a high-pressure refrigerant from the compressor 110 through the condenser 120 to the expansion valve 131, and a low-pressure pipe 152 for flowing a low-pressure refrigerant from the evaporator 141 to the compressor 110. The double tube 160 has a double tube structure at least a part of the pipe 150.

As shown in FIGS. 2 and 5, the double tube 160 has a total length of 700-900 mm, and plural bending portions 163 in order to avoid an interference with other device, e.g., engine 10, or a vehicle body. Then, the double tube 160 is positioned in the engine compartment 1.

The double tube 160 includes an outer tube 161 and an inner tube 162, which are respectively formed. The inner tube 162 passes through an inside of the outer tube 161. The outer tube 161 is a φ22 mm-tube (external diameter: 22 mm, internal diameter: 19.6 mm) made of aluminum, for example. An entire circumference of two ends of the outer tube 161 in a longitudinal direction is contracted and welded to a circumferential surface of the inner tube 162 (external diameter: 19.1 mm) air-tightly and liquid-tightly. Thus, a passage 160a is formed between an internal surface of the outer tube 161 and an external surface of the inner tube 162.

A circumferential wall has two communicating apertures 161a for communicating the passage 160a with an outside, at positions adjacent to the both ends of the outer tube 161. One of the apertures 161a is connected to the outlet of the condenser 120 through the high-pressure tube 151, and the other aperture 161a is connected to the inlet of the expansion valve 131 through the high-pressure tube 151. The passage 160a forms a part of the high-pressure tube 151, and the high-pressure refrigerant flows in the passage 160a.

In contrast, the inner tube 162 is a ¾ inch-tube (external diameter: 19.1 mm, internal diameter: 16.7 mm) made of aluminum, for example. That is, a cross-sectional area of the passage 160a is secured in order to communicate the high-pressure refrigerant, and its surface area is enlarged by making the external diameter of the inner tube 162 close to the outer tube 161, at the same time.

The inner tube 162 is longer than the outer tube 161. One of the ends of the inner tube 162 in a longitudinal direction is connected to the outlet of the evaporator 141 as the low-pressure pipe 152, and the other end is connected to the suction side of the compressor 110 as the low-pressure pipe 152. The low-pressure refrigerant flows in the inner tube 162.

A round groove 162c and a spiral groove 162a are formed on the external surface of the inner tube 162, to form an area of the passage 160a. The round grooves 162c are provided at positions corresponding to the communicating apertures 161a, and extend in a circumferential direction of the inner tube 162. The spiral groove 162a is connected to the round grooves 162c, and has multiple (three in this embodiment) threads spirally extending in a longitudinal direction of the inner tube 162 between the round grooves 162c. The passage 160a is enlarged by the grooves 162c, 162a.

Next, an operation based on the above structure and an advantage of the operation will be described with reference to a Mollier diagram shown in FIG. 6.

When an occupant of the automobile requires an air-conditioning for cooling, the electromagnetic clutch of the compressor 110 is connected. The compressor 110 is driven by the engine 10, and sucks and compresses refrigerant from the evaporator 141. Thereafter, the refrigerant is discharged from the compressor 110 to the condenser 120 as a high-temperature and high-pressure refrigerant. The high-pressure refrigerant is cooled in the condenser 120 to be a liquid phase. The liquid refrigerant flows through one of the high-pressure pipes 151, the passage 160a and the other high-pressure pipe 151, and is decompressed and expanded in the expansion valve 131. Then, the expanded refrigerant is evaporated in the evaporator 141, and made to be a saturated gas to have a superheat degree of 0-3° C. Air-conditioning air is cooled in accordance with the evaporation of the refrigerant in the evaporator 141. The saturated gas-phase refrigerant flows through one of the low-pressure pipes 152, the inner tube 162 and the other low-pressure pipe 152 as a low-temperature and low-pressure refrigerant, and returns to the compressor 110.

Here, the high-pressure refrigerant and the low-pressure refrigerant exchange heat in the double tube 160. The high-pressure refrigerant is cooled, and the low-pressure refrigerant is heated. (The low-pressure refrigerant is heated by 15° C. at maximum in this double tube 160.) That is, the liquid refrigerant flowing from the condenser 120 is supercooled in the double tube 160. Further, the saturated gas-phase refrigerant flowing from the evaporator 141 is heated mainly in the double tube 160 to be a gas-phase refrigerant to have a superheat degree of 18° C. (3° C.+15° C.) at maximum. The low-pressure refrigerant does not receive a radiant heat from the engine 10, because the inner tube 162 for communicating the low-pressure refrigerant is covered by the outer tube 161. Thus, lowering of a cooling performance can be reduced.

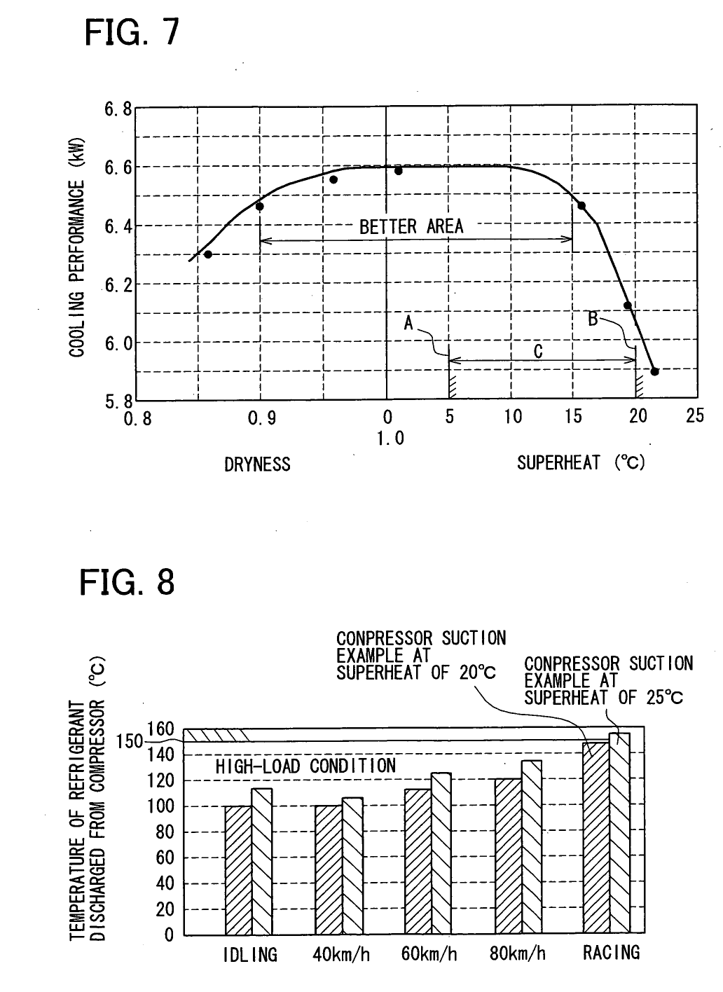

The expansion valve 131 controls an outlet side refrigerant state of the evaporator 141 to have a dryness equal to or larger than 0.9 and a superheat degree equal to or lower than 5° C. in the device 100A in this embodiment. As shown in FIG. 7, a cooling performance by the double tube 160 is increased, when the outlet side refrigerant of the double tube 160 is in a state where the dryness is equal to or larger than 0.9 and the superheat degree is equal to or lower than 15° C. A BETTER AREA in FIG. 7 represents a better area for the cooling performance of the double tube 160. A in FIG. 7 indicates an upper limit for a superheat degree at the outlet side of the evaporator. B in FIG. 7 indicates an upper limit for a superheat degree at the suction side of the compressor. C in FIG. 7 indicates a superheated degree by the double tube.

The low-pressure refrigerant flowing out of the evaporator 141 is superheated by 15° C. in maximum by using the high-pressure refrigerant in the double tube 160. Here, as shown in FIG. 8, at a high-load condition for cooling such as a racing in middle-summer (driving on a slope with a high-rotation of an engine), when the superheat degree of refrigerant at the suction side of the compressor 110 exceeds 20° C., a temperature of a compressed refrigerant is much increased. For example, the temperature of refrigerant discharged from the compressor 110 may exceed 150° C. If this state continues for a long time, or often happens, endurance performance of parts at the refrigerant discharging side of the compressor 110 may be decreased. When 15° C. superheated in the double tube 160 is subtracted from the super heat degree of 20° C. as an upper limit, the superheat degree of the outlet side refrigerant of the compressor 141 is restricted less than 5° C. In this embodiment, a pipe at the refrigerant discharging side of the compressor 110 is made of resin, e.g., synthesized resin, or rubber. If the temperature of the discharged refrigerant is decreased, endurance performance of the resin part is not reduced. Thus, the outlet side refrigerant of the evaporator 141 can be controlled to be in a range of a dryness equal to or larger than 0.9 and in a range of a superheat degree equal to or lower than 5° C. Accordingly, the cooling performance can be improved, and the endurance performance for parts at the high-pressure side can be secured in the refrigeration cycle device 100A.

Further, when the saturated liquid characteristic of the refrigerant used in the device 100A is moved in parallel along the temperature axis direction, the moved characteristic approximately corresponds to the saturated liquid characteristic of the working gas sealed in the first pressure room 131a of the expansion valve 131. Therefore, the thermal expansion valve 131 can operate with a predetermined superheat degree, even if an outlet side pressure of the evaporator 141 varies.

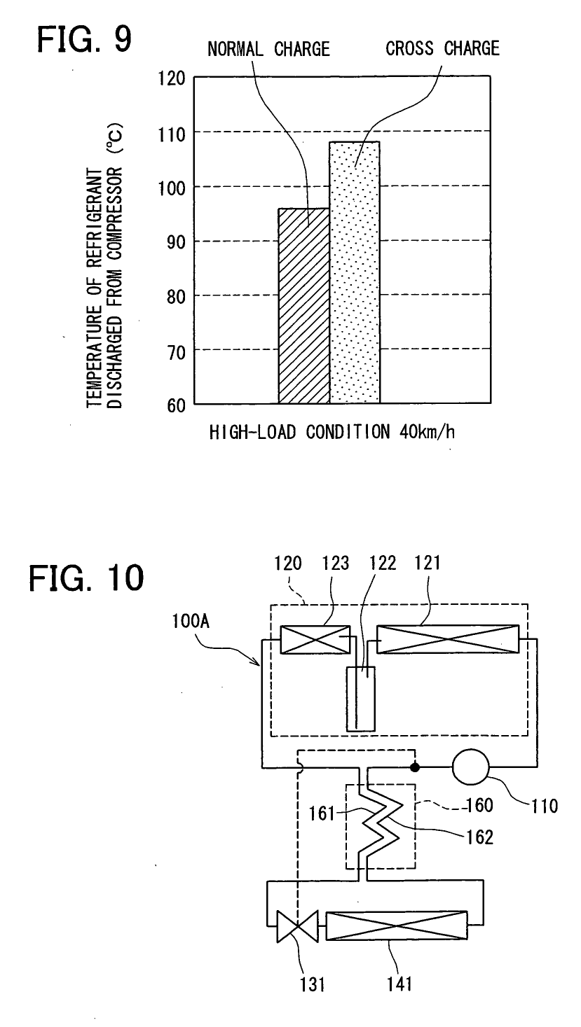

That is, if a gradient of the saturated liquid characteristic of the sealed gas is gradual relative to the saturated liquid characteristic of the refrigerant, as shown in a double-chained cross charge line in FIG. 4, a pressure of the sealed gas is difficult to increase. Then, the superheat degree at the refrigerant outlet side of the evaporator 141 may be easily increased, which is not favorable. As shown in FIG. 9, a sealed gas having a cross charge characteristic has a larger superheat degree than a sealed gas having a normal charge characteristic (the above-described parallel-moved characteristic). Thus, after refrigerant is compressed by the compressor 110, a temperature of the refrigerant is more increased.

Further, because the refrigerant of HFC-134a is used in the refrigeration cycle device 100A, pressure tightness of the outer tube 161 and the inner tube 162 of the double tube 160 can be maintained, and an efficient cooling performance can be obtained. As a characteristic of the HFC134a, when a refrigerant temperature in the evaporator 141 is about 0° C., a low-pressure refrigerant has a pressure of 0.2 MPaG. When a refrigerant temperature in the condenser 120 is about 60° C., a high-pressure refrigerant has a pressure of 2 MPaG. Thus, the refrigerant can have a predetermined range of temperature, and the double tube 160 can keep its pressure tightness in the range.

In addition, the upper limit for the superheat degree of the outlet side refrigerant of the evaporator 141 may be set about 0° C. In this case, the expansion valve 131 can control the outlet side refrigerant of the evaporator 141 in a range of a dryness equal to or larger than 0.9 and in a range of a superheat degree equal to or lower than 0° C. Thereby, the superheat degree at the refrigerant suction side of the compressor 110 is lowered by 5° C. (5° C.-0° C.). Then, the temperature of refrigerant compressed by the compressor 110 can be reduced due to the lowering in the superheat degree. Thus, a safe rate due to endurance performance of parts at a high-pressure side can be enhanced, especially in a high-load condition such as a racing in middle-summer. Further, the expansion valve 131 may control the outlet side refrigerant of the evaporator 141 to have a dryness equal to or more than 0.95.

Thus, the expansion valve 131 adjusts a refrigerant flow volume to be a predetermined value, and the refrigerant state is detected by a detecting portion. The predetermined value is set in accordance with a heat exchanging amount in the double tube 160, (which is disposed between the evaporator 141 and the compressor 110 as an internal heat exchanger) such that refrigerant drawn by the compressor 110 is in a predetermined state. By setting the predetermined value, the evaporator 141 can have a suitable cooling performance, and the temperature of refrigerant discharged from the compressor 110 is not extensively increased. Specifically, the outlet side refrigerant of the evaporator is controlled in an approximately saturated state by the predetermined value. For example, the predetermined value is in a range with a dryness equal to or larger than 0.9 and a superheat degree equal to or lower than 5° C., in which a liquid content is slightly left or the superheat degree is much small. Accordingly, a control target value of the expansion valve 131 is set, such that a small dryness or a small superheat degree lowered by a value corresponding to a heat exchanging amount by the double tube 160 is set for the outlet side refrigerant of the evaporator 110, compared with a case in which the expansion valve 131 is used in a refrigeration cycle device not including the double tube 160.

### Second Embodiment

A second embodiment of the present invention is shown in FIG. 10. An opening degree of an expansion valve 131 is controlled in accordance with a temperature of a suction side refrigerant of a compressor 110 in the second embodiment.

That is, a pressure of a first pressure room 131a of the expansion valve 131 varies in accordance with a temperature of refrigerant from a double tube 160 to a suction port of the compressor 110 (corresponding to the suction side refrigerant). Then, the suction side refrigerant of the compressor 110 has a predetermined superheat degree. The predetermined superheat degree may be set equal to or less than 20° C., similarly to the first embodiment. In addition, a condensing portion 121, a vapor-liquid separating portion 122 and a supercooling portion 123 are integrally formed in a condenser 120.

Thereby, the superheat degree of the suction side refrigerant can be directly controlled. Even when a heat-exchanging amount by the double tube 160 is rapidly increased, a temperature of refrigerant compressed by the compressor 110 can be reduced. Therefore, a cooling performance of the evaporator 141 is improved, and endurance performance for parts at a high-pressure side can be secured in a refrigeration cycle device 100A, similarly to the first embodiment.

### Third Embodiment

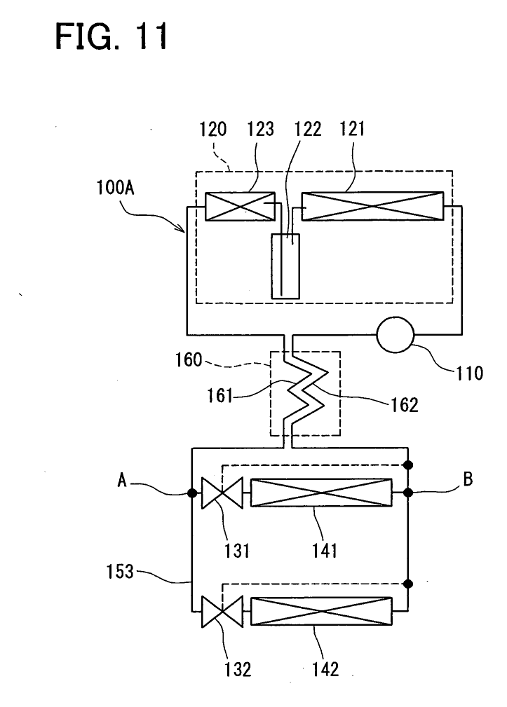

A third embodiment of the present invention is shown in FIG. 11. When a refrigeration cycle device 100A is a dual air-conditioner including another evaporator 142 for a rear seat in an automobile, a position of a double tube 160 is changed in the third embodiment.

The expansion valve 131 and the evaporator 141 in the first embodiment respectively correspond to a first expansion valve 131 and a first evaporator 142 in the third embodiment. The device 100A further includes a bypass passage 153, through which refrigerant bypasses the first expansion valve 131 and the first evaporator 141. A second expansion valve 132 (corresponding to a second decompressor) and a second evaporator 142 (corresponding to a second low-pressure side heat exchanger) are disposed in the bypass passage 153. A branch point A and a confluent point B are provided in the bypass passage 153.

An outer tube 161 of the double tube 160 is disposed between a condenser 120 and the branch point A, and an inner tube 162 is disposed between the confluent point B and a compressor 110.

An opening degree of the first expansion valve 131 is controlled in accordance with a temperature of refrigerant between the confluent point B and the double tube 160. Thus, an outlet side refrigerant of the first evaporator 141 is set in a range of a dryness equal to or larger than 0.9 and in a range of a superheat degree equal to or lower than 5° C. An opening degree of the second expansion valve 132 is controlled in accordance with a temperature of refrigerant between the second evaporator 142 and the confluent point B. Thus, an outlet side refrigerant (corresponding to an outlet side refrigerant of a second low-pressure side heat exchanger) of the second evaporator 142 is set in a range of a dryness equal to or larger than 0.9 and in a range of a superheat degree equal to or lower than 5° C.

Thereby, cooling performance can be improved in both of the evaporators 141, 142, because a high-pressure refrigerant supercooled by the double tube 160 can flow toward both of the first and second evaporators 141, 142 through the expansion valves 131, 132.

A superheat degree of the outlet side refrigerant can be reduced in the second evaporator 142, similarly to the first evaporator 141. Thus, a temperature of refrigerant compressed by the compressor 110 can be reduced.

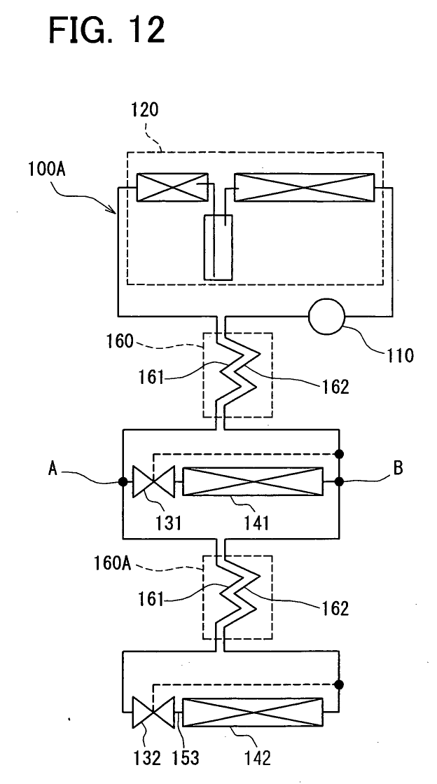

In addition, as shown in FIG. 12, a double tube 160A may be disposed in the third embodiment. That is, an outer tube 161 of the double tube 160A may be disposed between the branch point A and the second expansion valve 132, and an inner tube 162 of the double tube 160A may be disposed between the second evaporator 142 and the confluent point B.

Thereby, the cooling performance of the second evaporator 142 can be more improved, because a high-pressure refrigerant supercooled by the double tube 160A can flow toward the second evaporator 142 through the second expansion valve 132.

### Other Embodiments

Although the present invention has been fully described in connection with the preferred embodiments thereof with reference to the accompanying drawings, it is to be noted that various changes and modifications will become apparent to those skilled in the art.

For example, in the above embodiments, the thermal expansion valve 131 (132, 133) is used as a decompressor. Alternatively, a fixed throttle or a low-pressure expansion valve may be used as the decompressor, as long as the throttle or the low-pressure expansion valve can control the outlet side refrigerant of the evaporator in a range of a dryness equal to or larger than 0.9 and in a range of a superheat degree equal to or lower than 5° C., or the throttle or the valve can control the suction side refrigerant of the compressor to have a predetermined superheat degree.

Further, the refrigerant used in the refrigeration cycle device 100A is not limited to the HFC-134a. Other refrigerants may be used in the device 100A.

Further, the device 100A is used for the air-conditioning apparatus 100 for an automobile. Alternatively, the device 100A may be used for a home air-conditioning apparatus. In this case, an outside air of the outer tube 161 may be lower compared with air within the engine compartment 1. Therefore, a low-pressure refrigerant may flow in the passage 160a, and a high-pressure refrigerant may flow in the inner tube 162, based on a heat-exchanging performance between the high-pressure refrigerant and the low-pressure refrigerant.

Such changes and modifications are to be understood as being within the scope of the present invention as defined by the appended claims.

1-8. (canceled)

9. A refrigeration cycle device comprising:
a compressor for drawing and compressing refrigerant;
a high-pressure side heat exchanger which exchanges heat with high-pressure refrigerant discharged from the compressor;
a decompressor for decompressing the high-pressure refrigerant to be low-pressure refrigerant;
a low-pressure side heat exchanger which exchanges heat with the low-pressure refrigerant; and
a double tube including an outer tube, and an inner tube that is located inside the outer tube to define a first passage therebetween through which the high-pressure refrigerant flows, and a second passage inside the inner tube through which the low-pressure refrigerant flows, wherein
the decompressor controls a dryness and a superheat degree of an outlet side refrigerant flowing from an outlet of the low-pressure side heat exchanger to the second passage of the double tube in accordance with a temperature of the outlet side refrigerant or a suction side refrigerant flowing from the second passage of the double tube to a suction port of the compressor such that the dryness of the outlet side refrigerant is equal to or larger than 0.9 and the superheat degree of the outlet side refrigerant is equal to or lower than 5° C.

10. The refrigeration cycle device according to claim 1, wherein:
the decompressor is an expansion valve for controlling a state of the outlet side refrigerant, or a state of the suction side refrigerant by adjusting its opening degree in accordance with a temperature of the outlet side refrigerant or the suction side refrigerant,
the decompressor has an enclosed space sealed with a gas, in which a pressure of the gas varies in accordance with the temperature of the outlet side refrigerant or the suction side refrigerant to adjust the opening degree, and
the gas has a saturated characteristic, which approximately corresponds to a parallel-moved saturated characteristic obtained by moving a saturated characteristic of the refrigerant in parallel along a temperature axis direction of a saturated line graph.

11. The refrigeration cycle device according to claim 1, wherein:
the double tube is located to superheat the outlet side refrigerant such that the suction side refrigerant has a dryness equal to or larger than 0.9 and a superheat degree equal to or lower than 20° C.

12. The refrigeration cycle device according to claim 1, wherein:
the double tube has a heat exchanging amount such that the suction side refrigerant has a superheat degree of 20° C. at maximum, when the dryness of the outlet side refrigerant is equal to or larger than 0.9 and the superheat degree of the outlet side refrigerant is equal to or lower than 5° C.

13. The refrigeration cycle device according to claim 1, wherein:
the decompressor controls the superheat degree of the outlet side refrigerant to be about 0° C. at least at a high-load time.

14. The refrigeration cycle device according to claim 1, wherein:
the refrigerant is a HFC134a refrigerant.

15. The refrigeration cycle device according to claim 1, wherein:
the refrigerant circulates in an air-conditioning apparatus for a vehicle.

16. The refrigeration cycle device according to claim 1, wherein:
the decompressor and the low-pressure side heat exchanger respectively correspond to a first decompressor and a first low-pressure side heat exchanger,
the high-pressure refrigerant flowing from the first passage of the double tube bypasses the first decompressor and the first low-pressure side heat exchanger through a bypass passage in which a second decompressor and a second low-pressure side heat exchanger are disposed; and
the double tube is disposed such that heat is exchanged between the high-pressure refrigerant flowing into a branch point of the bypass passage and the low-pressure refrigerant from a confluent point of the bypass passage to the compressor.

17. The refrigeration cycle device according to claim 8, wherein:
the second decompressor controls a state of refrigerant flowing from an outlet of the second low-pressure side heat exchanger to the confluent point in a range of a dryness equal to or larger than 0.9 and in a range of a superheat equal to or lower than 5° C.

18. The refrigeration cycle device according to claim 1, wherein:
the compressor has an upper limit temperature in order to reduce a lowering in an endurance performance of resin parts disposed at a discharge side of the compressor, and
the outlet side refrigerant is controlled such that a temperature of refrigerant discharged from the compressor is equal to or less than the upper limit temperature, when the temperature of the refrigerant discharged from the compressor varies due to a load variation in a high-load area.
